(19) United States
(12) Patent Application Publication
(10) Pub. No.: US 2015/0282566 A1
(43) Pub. Date: Oct. 8, 2015

(54) SPORTS SHOE COMPRISING STUDS OR STUD RECEIVERS

(71) Applicants: Maximilian Gruhn, Marl (DE); Klaus Huelsmann, Haltern am See (DE); Karl Kuhmann, Duelmen (DE); Michael Beyer, Raesfeld (DE); Martin Risthaus, Olfen (DE); Jun Shi, Shanghai (CN)

(72) Inventors: Maximilian Gruhn, Marl (DE); Klaus Huelsmann, Haltern am See (DE); Karl Kuhmann, Duelmen (DE); Michael Beyer, Raesfeld (DE); Martin Risthaus, Olfen (DE); Jun Shi, Shanghai (CN)

(73) Assignee: EVONIK INDUSTRIES AG, Essen (DE)

(21) Appl. No.: 14/432,530

(22) PCT Filed: Jul. 10, 2014
(86) PCT No.: PCT/EP14/64831

§ 371 Date: Mar. 31, 2015

(30) Foreign Application Priority Data
Jul. 11, 2013 (DE) 102013213582.3

(51) Int. Cl. A43C 15/16; A43B 5/02; C09J 123/26; B29D 35/14; C09J 177/00; A43B 5/00; A43B 5/14

(52) U.S. Cl. CPC A43C 15/161; A43B 5/001; A43B 5/02; A43B 5/14; B29D 35/142; C09J 177/00; C09J 123/26; B29K 2063/00

(57) ABSTRACT

The invention relates to studded shoes which comprise metal studs and a plastics sole. Studs and sole are connected to one another by a coating of an adhesion promoter composition, wherein the composition comprises at least one copolyamide-based hot-melt adhesive. The studded shoe can be used in the sports sector or hiking sector.

The present invention relates to a sports shoe comprising studs or stud receivers, and also at least one plastics sole, to the corresponding shoe soles, and to production and use thereof.

It is known in the prior art that sports shoes or hiking shoes, and in particular football shoes, can be provided with studs in order to increase grip, in particular on soft ground such as natural turf. They are in particular used in all sports played on turf, for example to football, rugby, American football, baseball, or ultimate.

Studs are profiled projections beneath the shoe sole, and some methods of attachment of these studs can cause them to protrude into the shoe sole. The usual orientation of the studs with respect to the plane of the shoe sole is perpendicular, approximately perpendicular, or else optionally at an angle.

It is also possible per se that, instead of the studs, devices to receive the studs are introduced into the sole (stud receivers). In this case by way of example the studs can be screwed into the receivers. The stud receivers are also called stud footing.

The studs can also consist of various materials. It is usual to use studs made of metals or of plastics. It is usual here that the studs have an interlocking and/or frictional connection to the sole of the shoe.

It is disadvantageous that adhesion between the studs and the sole, usually manufactured from plastics, is inadequate. Under load, the studs can separate from the sole or break away. When the studs are subject to lateral loading (flexural loading) an intervening space or gap is formed between sole material and studs, and contaminants such as grass or sand can penetrate within said intervening space or gap. This causes not only impaired appearance but also increased wear and tear.

It was therefore an object of the present invention to provide a sports shoe comprising studs and, respectively, stud receivers, and also a plastics sole (studded shoe), where these do not have the disadvantages of the prior art. The studs should have improved adhesion to the sole. It is thus possible to ensure improved force transmission and, respectively, distribution. Penetration of contaminants when flexural loading is applied should be suppressed or at least to some extent eliminated. The studded shoe should moreover exhibit reduced weight combined with at least equivalent adhesion.

Surprisingly, sports shoe have been found which do not have the disadvantages of the prior art. Accordingly, sports shoes of the type mentioned in the introduction can be provided where the studs and, respectively, stud receivers of said shoes, preferably studs, and soles are connected to one another at least by a coating of an adhesion promoter composition, where the composition comprises at least one copolyamide-based hot-melt adhesive. The longitudinal direction (axis of symmetry) of the studs here is usually perpendicular to the plane of the sole or almost perpendicular (deflection of the axis of symmetry: from 85° to <90°) or at an angle (deflection of the axis of symmetry from 40° to <85°). Angled positioning of the studs therefore usually comprises angles greater than from 0° to 50° between the sole and the perpendicular to the sole.

To that extent, a portion of the studs therefore protrudes from the sole in order to create the desired grip, and a portion protrudes into the sole in order to provide the bond to the sole.

The sports shoes of the invention also comprise receivers for studs. The studs here can by way of example be screwed into the receivers or can be secured by another means, for example by magnetism. The receivers are connected to the sole by at least one coating of an adhesion promoter composition. Studs and stud receivers form the stud material.

The stud receivers can also be suitable for receiving cleats of the type used in competitive cycling for connection to a clipless pedal.

The stud receivers can moreover receive devices on ski shoes or on ski boots for retaining the ski binding.

Other embodiments of the invention are found in the dependent claims.

The plastics shoe soles of the sports shoes of the invention comprising studs and, respectively, stud receivers are also provided by the invention. The shoe soles of the invention form, with optionally present other soles such as insoles or midsoles, the base of a shoe. The second main constituent of the shoe is the upper.

The invention further provides a process for the production of the abovementioned sports shoes, where the adhesion promoter composition is applied at least to some extent to the surface of the studs or stud receivers, and the studs and, respectively, stud receivers are then connected to the plastic that forms the sole (process 1). In an alternative process, the adhesion promoter composition is applied at least to some extent to the sole, and the sole is then connected to the studs and, respectively, stud receivers (process 2). Process 1 is a preferred process of the invention.

The adhesion promoter composition (hereinafter also termed composition) can be applied over the entire area or partially to the studs, the stud receivers, or the sole, preferably to studs and, respectively, stud receivers.

The stud material with the applied adhesion promoter composition can be crosslinked and, respectively, dried thermally, advantageous temperatures here being from 80° C. to 240° C., preferably from 120° C. to 225° C., more preferably from 175° C. to 220° C., for a period of from 0.5 min to 20 min, preferably from 1 min to 10 min, more preferably from 3 min to 8 min. In the case of roll processes, preference is given to temperatures of from 150° C. to 230° C., and to times of from 50 s to 3 min.

The compositions are therefore cured thermally.

The compositions can be applied continuously or batchwise by means of electrophoretic enamelling, electrostatic spray processes, fluidized-bed sintering, roll processes (for example coil coating), casting, jet processes and spraying, lamination, (hot) pressing, or (co)extrusion, preference being given here to spray processes and application processes using rolls. The compositions here can be applied on one or both sides, locally or over the entire area. The stoved layer thicknesses (dry layer thicknesses) of the adhesion promoter compositions can be from 10 to 1000 μm, preferably from 20 to 250 μm, and more preferably from 30 to 150 μm. Preferred layer thicknesses in roll processes are from 10 μm to 50 μm.

The plastic of the shoe sole is then produced by way of example by an injection-moulding process, thermoforming, or hot pressing, and applied in accordance with process 1 to the stud material, and the stud material is physically connected and/or chemically bonded to the plastic. Preference is given to the injection-moulding process and to the thermoforming process.

In the production of the studded shoe of the invention, the advantage lies in a process sequence that is shorter than in processes of the prior art in which studs and, respectively, stud receivers are adhesive-bonded into the previously produced sole (post-bonding). Especially with the injection-moulding process and the thermoforming process there is no requirement for post-bonding.

Accordingly, a preferred embodiment of the invention avoids post-bonding of the studs and, respectively, stud receivers.

It is particularly preferable to use injection-moulding technology to inject the plastic. For this, the coated stud material is inserted into the injection mould and, after closing of the mould, is in-mould-coated with the plastic. Contact of the plastics melt with the coated stud material surface produces a coherent bond and, respectively, the adhesion between the components. The coherently bonded component made of shoe sole and studs can then be demoulded from the injection mould and subjected to further processing or further mechanical operations.

By virtue of the coherent bond between sole material and stud material it is possible to achieve markedly advantageous force distribution and consequently to produce a stiffer overall design of the stud structure. Less contamination collects between stud and sole, and increased stability of the studs is thus ensured. The coherent bond prevents extraction of the stud under tensile loading. The regions of the studs peripheral to the studs have less susceptibility to cracking.

Another advantage resulting by virtue of the coherent bond is weight reduction, since the area of the stud material that must be connected to the sole is smaller than in the case of interlocking of frictional connections by virtue of the improved adhesion. Alternatively, for a comparable area, it is possible to obtain stiffer deformation behaviour and, respectively, better sole-stud-substrate force transmission, since less relative stud/sole movement is permitted.

The combination of stud material and plastic can then be subjected to a heat treatment for from 2 min to 90 min, preferably from 5 min to 60 min, at from 70° C. to 230° C., in order to increase bond strength and degree of crosslinking. Components produced in this way, made of shoe sole and studs, have a durable connection between the pretreated and coated stud material and the plastic, and exhibit high mechanical and dynamic strength.

The invention analogously also provides a process for the production of the plastics shoe soles of the invention. The plastics shoe soles comprising the studs or stud receivers can be used for the production of the sports shoes, the production process being familiar to the person skilled in the art.

The invention further provides the use of the sports shoes of the invention for hiking or climbing, and in sports such as football, rugby, American football, gold, athletics, baseball, or ultimate, in particular on natural turf, synthetic turf, cinders, or synthetic tracks such as Tartan tracks. The sports shoes comprising stud receivers can equally be used in cycling as cycling shoe, to the extent that they are capable of receiving cleats. The studded shoes can moreover be used as crampons for icy or smooth surfaces. The sports shoes comprising stud receivers can moreover be used in skiing as ski shoes or ski boots, to the extent that they are capable of receiving ski binding retainers or have a locking system suitable for ski binding retainers.

The studded shoes are preferably used for sports such as football, rugby, American football, golf, athletics, baseball, or ultimate, in particular on natural turf, synthetic turf, cinders, or synthetic tracks such as Tartan tracks.

A very particularly preferred embodiment of the invention is a sports shoe with studs comprising metal and with a sole obtained by an injection-moulding process or by thermoforming. No post-bonding of the stud material to the sole takes place here.

### Conversion Layer

Before the application of the adhesion promoter compositions, it is possible to apply a conversion layer to the stud material, over the entire area or partially, in order to pretreat the surface. It is preferable that the pretreatment takes place in the case of metallic stud material. The stud material can be cleaned before the preatment, or can have metallic protective coatings. The metal cleaning process is known to the person skilled in the art.

The pretreatment can use converting agents. The converting agents are usually used in the form of aqueous solutions. Converting agents that can be used are commercially available passivating agents and products for conversion treatment, for example zinc phosphating agents, iron phosphating agents, and also phosphoric acid solutions comprising titanates or zirconates. From a technical point of view it is likewise possible to use chromating agents, but these are less preferred because they are hazardous to health.

It is moreover possible to obtain the conversion layer by flame-pyrolytic deposition of amorphous silicate on the surface of the stud material. The surface to be treated is passed through the oxidizing region of a gas flame into which a silicon-containing substance, the precursor, has been dosed. This is consumed by combustion, and the residue deposits in the form of amorphous silicate as firmly adhering layer in layer thicknesses of about 20 to 40 nm on the surface.

Treatment of a surface is achieved by using an operating gas to produce a plasma jet or a combustion gas to produce a flame jet, this being used to coat the surface, where at least one precursor material is introduced into the operating gas and/or into the plasma jet or into the combustion gas and/or into the flame jet, and is reacted in the plasma jet or flame jet, where at least one reaction product of at least one of the precursors is deposited on the surface and/or on at least one layer arranged on the surface. A process of this type is described by way of example in DE-A-102009042103.

### Stud and Stud Material

The profiled projections beneath the shoe sole have the shape of cylinders, blocks, cones, or crowns, or can be triangular. The studs can have passages, flanges, cavities, depressions, or rough areas into which the plastic of the sole material can be introduced. This achieves even higher adhesion between stud and sole. Spikes of spiked shoes used by way of example in athletics or in golf likewise form studs for the purposes of the invention.

Suitable stud material is selected from metals and plastics. The stud material preferably comprises, or consists of, metal

Plastics suitable as stud material comprise thermoplastics, thermosets, and elastomers. The plastics can comprise reinforcement (reinforcing materials), preference being given here to glass-fibre-reinforced (GF), carbon-fibre-reinforced (CF), aramid-fibre-reinforced, or natural-fibre-reinforced plastics. The plastics can moreover comprise fillers such as talc powder, corundum, MoS₂, graphite, quartz, or chalk.

To the extent that plastics are used as stud material, these are preferably different from the material of the plastics sole.

Examples of suitable metals are iron-containing alloys such as steel, aluminium, copper, magnesium, titanium, and also alloys of the abovementioned metals. Preferred metals are steel, titanium, aluminium, and also alloys of the abovementioned metals, particular preference being given to steel and aluminium, and aluminium alloys.

Preferred steels are non-alloy steels or low-alloy steels in accordance with DIN EN 10020.

Steels with a protective coating are particularly preferred. Suitable coatings are by way of example coatings made of zinc, nickel, chromium, aluminium-silicon, aluminium-zinc, zinc-aluminium, zinc-iron or zinc-magnesium, preference being given here to aluminium-silicon, zinc-aluminium and zinc. The composition of the coatings is defined by way of example in the brochure “Schmelztauchveredeltes Band und Blech” [Hot-dip-coated Strip and Sheet] of the Steel Information Centre in the Stahl-Zentrum, Dusseldorf, Germany, 2010 Edition.

The studs can be multimaterial composites where the material in the core of the stud is different from the material in the external layer. By way of example, a stud could have a metal core and an external plastics layer.

The material of the stud and of the stud receiver can be identical or different.

Before the application of the sole plastic, the stud material can be subjected to a trimming or forming process. The forming process can take place before or after the application of the adhesion promoter composition. In order to improve the adhesion of the interlocking or frictional connection, the studs can be L-shaped or have similar branched characteristics within the shoe sole material.

Regions of the metal studs projecting from the sole can at least to some extent have a covering of materials such as plastics.

There is in principle no restriction on the shape, size, length, number and arrangement of the studs on the sole. These characteristics are in particular appropriate for the application sector, and also the rules of the respective sport. Requirements of this type are familiar to the person skilled in the art.

### Plastics Sole

The plastic can be applied to the coated metal in a known manner, e.g. by injection moulding, compression, lamination, thermoforming, or (co)extrusion. Injection-moulding technology is preferably used to inject the plastic. The metal provided with the coatings can have been subjected to preconditioning in the range from 50° C. to 250° C. in order to raise the temperature in the region of contact with the plastic, e.g. in the case of in-mould coating for good bonding between the adhesion promoter and the plastic.

Suitable plastics comprise by way of example polybutylene terephthalates, polyolefins, polycarbonates, polyurethanes, aliphatic or semiaromatic polyamides, plastics mixtures comprising polyamides, styrene polymers such as acrylonitrile-butadiene-styrene, polyalkyl (meth)acrylates such as polymethyl methacrylate, and also mixtures of the abovementioned plastics. Mixtures of polycarbonates and acrylonitrile-butadiene-styrene are likewise suitable. Preference is given to aliphatic or semiaromatic polyamides, plastics mixtures comprising polyamides, polybutylene terephthalates, polyolefins, and also mixtures of the abovementioned plastics, particular preference being given here to polyamides. The plastics can comprise reinforcement (reinforcing materials), and preference is given here to glass-fibre-reinforced (GF), carbon-fibre-reinforced (CF), aramid-fibre-reinforced or natural-fibre-reinforced plastics, and particular preference being given here to glass-fibre-reinforced or carbon-fibre-reinforced plastics. The plastics can moreover comprise fillers such as talc powder or chalk.

Preferred polyamides are selected from the group consisting of polyamide 6, polyamide 6-3T, polyamide 6.6, polyamide 610, polyamide 612, polyamide 613, polyamide 1010, polyamide 11, polyamide 12, polyamide 1012, polyphthalamides, optically transparent polyamides, block polyetheramides and mixtures and copolymers based on these polyamides. Particularly preferred polyamides are selected from polyamide 6, polyamide 6.6, polyamide 610, polyamide 1010, polyamide 11, polyamide 12, polyamide 1012, block polyetheramides and mixtures of these. The polyamides can comprise reinforcing materials, fillers or mixtures of these substances. Suitable polyamides are available by way of example as VESTAMID EX9200 from Evonik Industries AG.

Suitable block polyetheramides are described by way of example in EP-A-1693415.

Optically transparent polyamides comprise microcrystalline polyamides comprising linear aliphatic dicarboxylic acids and cycloaliphatic diamines, amorphous polyamides comprising linear aliphatic dicarboxylic acids and cycloaliphatic diamines and optionally lactams and, respectively, aminocarboxylic acids, amorphous polyamides comprising terephthalic acid and cycloaliphatic or branched aliphatic diamines and optionally lactams and, respectively, aminocarboxylic acids or amorphous polyamides comprising isophthalic acid and cycloaliphatic or linear or branched aliphatic diamines and optionally lactams and, respectively, aminocarboxylic acids. Suitable optically transparent polyamides are by way of example amides made of dodecanedioic acid and of an isomer mixture of 4,4′-bis(aminocyclohexyl)methane, of terephthalic acid and of the isomer mixture of 2,2,4- and 2,4,4-trimethylhexamethylenediamine, of dodecanedioic acid and of the isomer mixture of 3,3′-dimethyl-4,4′-bis(aminocyclohexyl)methane, of laurolactam, isophthalic acid and of the isomer mixture of 3,3′-dimethyl-4,4′-bis(aminocyclohexyl)methane or of tetradecanedioic acid and of the isomer mixture of 3,3′-dimethyl-4,4′-bis(aminocyclohexyl)methane. Polyamides of this type are described by way of example in DE-A-102007062063 or WO-A-2008025729. The optically transparent polyamides can be used in mixtures or in the form of copolyamides. Optically transparent polyamides are available by way of example with trade names Trogamid (Evonik Industries AG, Germany), Grilamid (EMS-Chemie, Switzerland), Rilsan (Arkema, France) or Durethan (Lanxess, Germany). Examples of suitable optically transparent polyamides are Trogamid CX7323, Trogamid CX9704, Gilamid, TR90, Grilamid TR55 or RILSAN Clear.

### Adhesion Promoter Composition

The adhesion promoter composition comprises at least one copolyamide-based hot-melt adhesive. The adhesion promoter composition can be present in solution or in dispersion, or in the form of solid.

The hot-melt adhesive comprises at least one copolyamide. The copolyamide can be produced from amide monomers and from comonomers. The comonomers are preferably used to obtain copolyamides with melting point from 95° C. to 175° C.

The amide monomers are preferably selected from the group consisting of laurolactam, aminoundecanoic acid and mixtures thereof. Particular preference is given to copolyamides based on laurolactam.

The comonomers are preferably selected from aliphatic or cycloaliphatic diamines, aliphatic or cycloaliphatic dicarboxylic acids, lactams and mixtures thereof. The comonomers preferably comprise, mutually independently, from 4 to 18 C atoms. Suitable dicarboxylic acids are by way of example adipic aicd, sebacic acid and dodecanedioic acid. Suitable diamines are by way of example hexamethylenediamine, decamethylenediamine and dodecamethylenediamine. Lactams such as captrolactam can likewise be used as comonomer.

Preferred comonomers are caprolactam and a polymer made with adipic acid and hexamethylenediamine, preferably in a ratio by mass of 1:1.

An excess of amine groups in the diamines gives copolyamides having reactive amino end groups.

The amine numbers of the copolyamides are preferably from 75 to 400 mmol/kg.

The weight-average molar mass of the copolyamides is preferably in the range from 15 000 to 70 000 g/mol (measured by means of gel permeation chromatography (GPC) against a polystyrene standard). The relative solution viscosity is preferably from 1.2 to 1.8 (determined in accordance with ISO 307).

The copolyamides and, respectively, the hot-melt adhesive can be used in the formulations in solution, in dispersion or in powder form, preference being given here to the powder form. A suitable solvent is by way of example m-cresol.

The powder form can by way of example be obtained by milling, the grain diameter here preferably being <200 μm, more preferably <100 μm and yet more preferably <70 μm

In one preferred embodiment of the invention, at least one epoxy component and at least one blocked polyisocyanate have been added to the copolyamide, as other constituents of the hot-melt adhesive.

Compounds based on diols or on polyols or dicarboxylic acids can by way of example be used as epoxy component, preference being given here to diols and particular preference being given here to corresponding phenol-diol derivatives. Very particularly preferred phenol-diol derivatives are bisphenols, in particular bisphenol A. The epoxy component is usually obtained by reaction with epichlorohydrin. The epoxy index of the epoxy component is typically from 1 to 2 eq/kg. The epoxy equivalent weight is preferably from 875 to 1000 g/mol. The density can be from 1.1 to 1.3 kg/L, preferably from 1.15 to 1.25 kg/L. The glass transition temperature is usually in the range from 40 to 60° C., preferably from 45 to 55° C. The hot-melt adhesive preferably comprises a proportion of from 2.5 to 10% by weight of the epoxy component, more preferably from 4 to 6% by weight, based in each case on the total weight of the hot-melt adhesive.

The proportion of blocked polyisocyanate is preferably from 2.5 to 15% by weight, more preferably from 4 to 6% by weight, based in each case on the total weight of the hot-melt adhesive.

The blocked polyisocyanate component can be aromatic, aliphatic or cycloaliphatic, preference being given here to aliphatic or cycloaliphatic polyisocyanates. Blocking agents for isocyanates such as oximes, phenols or caprolactam are known to the person skilled in the art. It is preferable that, for blocking purposes, the polyisocyanate component takes the form of uretdione. Typical examples are marketed as VESTAGON by Evonik Industries AG, Germany.

The adhesion promoter composition can comprise self-crosslinking or externally crosslinking binders (in relation to the term “Bindemittel” [Binders] cf. Römpp Lexikon Lacke and Druckfarben [Römpp's Encyclopaedia of Coating Materials and Printing Inks], Georg Thieme Verlag, Stuttgart, New York, 1998, Bindemittel, pp. 73 and 74). For the purposes of the present invention, the term “self-crosslinking” denotes the property of a binder of entering into crosslinking reactions with itself. Precondition for this is that complementary reactive functional groups are present in the binders and react with one another and thus lead to crosslinking. Or else the binders comprise reactive functional groups which react “with themselves”. Binder systems described as externally crosslinking are in contrast those in which one type of the complementary reactive functional groups is present in the binder and the other type is present in a hardener or crosslinking agent. For additional information here, reference is made to Römpp Lexikon Lacke and Druckfarben [Römpp's Encyclopaedia of Coating Materials and Printing Inks], Georg Thieme Verlag, Stuttgart, New York, 1998, Härtung [Curing], pp. 274 to 276, in particular lower part of p. 275.

The adhesion promoter composition can moreover comprise electrically conductive substances selected from graphite, carbon black, zinc dust and mixtures of these substances, thus giving electrically conductive adhesion promoter compositions.

The metal studs comprising coatings of electrically conductive adhesion promoter compositions can be provided with a cathodic electrocoat (CEC).

The adhesion promoter compositions can moreover comprise colorants, preferably pigments. Functional pigments such as corrosion-protection pigments can moreover be present.

Suitable hot-melt adhesives are available by way of example as VESTAMELT from Evonik Industries AG, Germany. Examples that may be mentioned are X1027-P1, X1038-P1, X1316 P1 and X1333-P1.

Even without further observations, it is assumed that a skilled person is able to utilize the above description to its widest extent. The preferred embodiments and examples are therefore to be interpreted merely as a descriptive disclosure which is by no means limiting in any way whatsoever.

The present invention is elucidated in more detail below using examples. Alternative embodiments of the present invention are obtainable analogously.

### EXAMPLES

The adhesion of the studs in a plastics sole was simulated by metal strips to which adhesion promoter compositions were first applied. The coated metal strips were then in-mould-coated with various plastics, and the adhesion between metal and plastic was tested. The metal strip was in-mould-coated with the plastic on one side (experimental series I) or on two sides (experimental series II).

I. Test Samples with Single-Side Plastics Coating

Structure: Metal—Adhesion Promoter Composition—Plastic

Converting agents were used to phosphate metal sheets (sheet thickness 1.5 mm) which have not been pretreated. Granodine 958 A from Henkel, Germany was used as is converting agent, comprising inter alia phosphoric acid and zinc bis(dihydrogenphosphate), and Deoxylyte 54NC was used for post-passivation. The following metal alloys were used as material for the metal sheet:
M1: Aluminium 5754 H111
M2: Stainless steel 1.4516
M3: Galvanized steel DX51D Z140 in accordance with DIN EN 10346
M4: Steel ZSTE 800 in accordance with DIN EN10142

The conversion solution was applied in accordance with manufacturer's instructions by means of immersion into the solutions and drying of the layers, and then the metal samples were coated with an adhesion promoter composition. The composition applied comprised

H1: Copolyamide-based hot-melt adhesive (Vestamelt X1333-P1 from Evonik Industries AG) comprising an epoxy component and a blocked polyisocyanate in the form of powder coating and

H2: Solvent-containing spray coating comprising about 30% by weight of a copolyamide-based hot-melt adhesive comprising an epoxy component and a blocked polyisocyanate and

H3: Copolyamide-based hot-melt adhesive (Vestamelt Z2366-P1 from Evonik Industries AG) comprising an epoxy component and a blocked polyisocyanate, and also a functionalized polyolefin, as powder coating.

Compositions H1, H2 and H3 comprise the same copolyamide. Composition H2 (spray coating) was applied by the spray process with a layer thickness of from 50 to 70 μm, and compositions H1 and H3 were applied electrostatically with a layer thickness of from 50 to 100 μm. Composition H2 was stoved for 5 min at 175° C., and the powder coating was stoved for 5 min at 200° C. For this, the coated metal sheets were placed in a preheated autoclave (oven).

After the stoving procedure, guillotine shears were used to cut the metal sheets into strips fitting the injection-moulding cavity with dimensions 24.9 mm×59.8 mm (tolerance ±0.2 mm) or 20.0 mm×50.0 mm (tolerance +0−0.2 mm).

For production of the final test samples, the strips were then placed in a temperature-controlled injection mould and in-mould-coated with a thermoplastic. The following moulding compositions were used as plastics component:
K1: VESTAMID LX9012 from Evonik Industries AG
K2: TROGAMID CX7323 from Evonik Industries AG
K3: VESTAMID Terra HS1850 from Evonik Industries AG
K4: VESTAMID Terra BS1429 from Evonik Industries AG
K5: Durethan BKV30 H2.0 from LANXESS Germany GmbH
K6: Celstran PP-GF30-05CN01 from TICONA
K7: VESTAMID HTplus M1035 from Evonik Industries AG
K8: VESTAMID L-GF30 from Evonik Industries AG.

The plastic was processed in an Allrounder 420 (screw diameter 25 mm) at a melt temperature of 280° C., a mould temperature of 80° C., and an injection rate of about 30 ccm/s. However, for the PPAGF50 and, respectively, PPLGF30 mould temperatures were 120° C. and, respectively, 70° C. and melt temperatures used were 335° C. and, respectively, 270°. It was important here to provide an injection delay of about 30 s, so that the metal sheet strip inserted could be preheated to mould temperature, giving a favourable effect on adhesion. After demoulding, the individual tensile shear test samples were separated from the sprue.

The test samples used had the following physical features:

| | | | | | Thickness of |
|---|---|---|---|---|---|
| | | | | Thickness of | plastics |
| | Length | Width | Overlap | metal sheet | component |
| Type | in mm | in mm | in mm² | in mm | in mm |
| 1 | 130 | 25 | 25 × 1025 | 1 | 4 |
| 2 | 130 | 25 | 12.5 × 1025 | 1 | 4 |
| 3 | 100 | 20 | 20 × 1020 | 1.5 | 6 (4 mm in the |
| | | | | | overlap region) |

The test samples thus produced were stored at 50% relative humidity for at least 24 h at 23° C. in order to ensure a uniform state of conditioning. The test samples were then clamped into a standard Zwick/Roell Z-020 tensile tester and tested with a velocity of 5 mm/min at 23° C. with a distance of about 15 mm/side between the clamps and the overlap region.

| | | Adhesion | | Adhesion |
|---|---|---|---|---|
| Plastic | Metal | promoter | Test sample | in MPa |
| K1 | M1 | none | 25 × 25 | 0 |
| K1 | M1 | H1 | 25 × 25 | 4.5 |
| K1 | M2 | none | 25 × 25 | 0 |
| K1 | M2 | H1 | 25 × 25 | 4.6 |
| K2 | M3 | none | 25 × 25 | 0 |
| K2 | M3 | H1 | 25 × 25 | 4.8 |
| K2 | M3 | H2 | 25 × 25 | 3.7 |
| K3 | M1 | none | 12.5 × 25 | 0 |
| K3 | M1 | H1 | 12.5 × 25 | 11.3 |
| K3 | M1 | H2 | 12.5 × 25 | 14.7 |
| K3 | M3 | none | 12.5 × 25 | 0 |
| K3 | M3 | H1 | 12.5 × 25 | 16.0 |
| K3 | M3 | H2 | 12.5 × 25 | 15.5 |
| K4 | M1 | none | 12.5 × 25 | 0 |
| K4 | M1 | H2 | 12.5 × 25 | 7.9 |
| K4 | M3 | none | 12.5 × 25 | 0 |
| K4 | M3 | H2 | 12.5 × 25 | 15.7 |
| K5 | M1 | none | 12.5 × 25 | 0 |
| K5 | M1 | H1 | 12.5 × 25 | 13.0 |
| K5 | M1 | H2 | 12.5 × 25 | 13.9 |
| K5 | M3 | none | 12.5 × 25 | 0 |
| K5 | M3 | H1 | 12.5 × 25 | 13.8 |
| K5 | M3 | H2 | 12.5 × 25 | 12.3 |
| K6 | M1 | none | 12.5 × 25 | 0 |
| K6 | M1 | H3 | 12.5 × 25 | 5.8 |
| K7 | M3 | none | 12.5 × 25 | 1 |
| K7 | M3 | H2 | 12.5 × 25 | 11.9 |
| K8 | M4 | none | 20 × 20 | 0 |
| K8 | M4 | H1 | 20 × 20 | 8.8 |
| K8 | M4 | H2 | 20 × 20 | 10.6 |

The results show that by virtue of the coherent bond using adhesion promoter coating it is possible to achieve increased bond strength between plastic and metal, when comparison is made with test samples with interlocking connection, without adhesion promoter.

II. Test Samples with Plastics Coating on Both Sides

Structure: Plastics—Adhesion Promoter Composition—Metal—Adhesion Promoter Composition—Plastic

Unlike in experimental structure I, the plastic was applied on both sides of the metal sheet. This gave test samples surrounded on three sides by plastic; the plastic here formed a U shape around the metal sheet.

Converting agents were used to phosphate steel sheets (galvanized steel DX51D Z140 in accordance with DIN EN 10346) that had not been pretreated. Granodine 958 A from Henkel, Germany was used as converting agent, comprising inter alia phosphoric acid and zinc bis(dihydrogenphosphate).

The conversion solution was applied in accordance with manufacturer's instructions by means of immersion into the solutions and drying of the layers, and then the metal samples were coated with an adhesion promoter composition. The composition applied comprised
H1: VESTAMELT X1333 as power coating,
H2: Solvent-containing spray coating comprising about 30% by weight of VESTAMELT X 1333.

Composition H2 (spray coating) was applied by the spray process with a layer thickness of from 50 to 70 μm, and composition H1 was applied electrostatically with a layer thickness of from 50 to 100 μm. Composition H2 was stoved for 5 min at 175° C., and the powder coating was stoved for 5 min at 200° C. For this, the coated metal sheets were placed in a preheated autoclave (oven).

After the stoving procedure, guillotine shears were used to cut the metal sheets into strips fitting the injection-moulding cavity with dimensions 20.0 mm×50.0 mm (tolerance ±0.2 mm).

For production of the final test samples, the strips were then placed in a temperature-controlled injection mould and in-mould-coated with a thermoplastic. A polyamide 6 was used as plastics component GF30 (Durethan BKV30 H2.0 from Lanxess, Germany). The plastic was processed in an Arburg V370 injection-moulding machine at a melt temperature of 280° C., a mould temperature of 80° C., and an injection rate of about 30 ccm/s. It was important here to provide an injection delay of about 15 s, so that the metal sheet strip inserted could be preheated to mould temperature, giving a favourable effect on adhesion. Possible overlap lengths between plastic and metal that can be produced with the mould are 10×20 mm. After demoulding, the individual tensile shear test samples were separated from the sprue.

The test samples thus produced were stored at 50% relative humidity for at least 24 h at 23° C. in order to ensure a uniform state of conditioning. The test samples were then clamped into a standard Zwick/Roell Z-020 tensile tester and tested with an overlap region of about 15 mm/side.

| | Adhesion | Adhesion |
|---|---|---|
| Plastic | promoter | in MPa |
| K1 | none | 1.6 |
| K1 | H1 | 21.4 |
| K1 | H2 | 18.2 |

The results show that by virtue of the coherent bond using adhesion promoter coating it is possible to achieve increased bond strength between plastic and metal, when comparison is made with test samples with interlocking connection, without adhesion promoter.

1: A sports shoe comprising:
studs or stud receivers,
a plastic sole, and
an adhesion promoter composition that comprises at least one copolyamide-based hot-melt adhesive;
wherein the studs and, respectively, stud receivers and plastic sole are connected to one another at least by a coating of the adhesion promoter composition.

2: The sports shoe according to claim 1, wherein the copolyamide comprises additions of at least one epoxy component and of at least one blocked polyisocyanate, as other constituents of the hot-melt adhesive.

3: The sports shoe according to claim 1, that comprises studs, wherein the longitudinal direction of the studs is perpendicular, almost perpendicular, or at an angle, to the plane of the sole.

4: The sports shoe according to claim 1, that comprises studs comprising at least one material selected from the group consisting of metal and plastic.

5: The sports shoe according to claim 1, wherein the plastic sole is applied by an injection-moulding process, by thermoforming, or by hot pressing onto the stud material.

6: A plastic shoe sole comprising:
a plastic sole,
studs or stud receivers, and
an adhesion promoter composition that comprises at least one copolyamide-based hot-melt adhesive;
wherein the studs and, respectively, stud receivers, and the plastic sole are connected to one another at least by a coating of the adhesion promoter composition.

7: A process for producing a sports shoe, according to claim 1, wherein the adhesion promoter composition is applied at least to some extent to the surface of the sole and the sole is then connected to the stud material.

8: A process for producing a sports shoe according to claim 1, wherein the adhesion promoter composition is applied at least to some extent to the surface of the stud material and the stud material is then connected to the plastic that forms the sole.

9: The process according to claim 8, wherein the adhesion promoter composition is cured thermally.

10: The process according to claim 8, wherein the plastic sole is applied by an injection-moulding process, by thermoforming, or by hot pressing onto the stud material.

11: A sports shoe according to claim 1 comprising studs or stud receivers, wherein said sports shoe is a hiking or climbing shoe, or a football, rugby, American football, golf, baseball, ultimate, cycling, skiing or athletics shoe.

12: The sports shoe according to claim 11 wherein said shoe is suitable for use on natural or synthetic turf, cinders, or a synthetic track.

13: The shoe according to claim 1, wherein said shoe is lighter in weight than an otherwise identical shoe in which the studs or stud receivers and plastic sole are frictionally-interlocked and not coherently-bonded to one another by a coating of said hot-melt adhesion promoter composition.

14: The sports shoe according to claim 1, wherein said shoe provides a higher sole-substrate force transmission than an otherwise identical shoe in which the studs or stud receivers and plastic sole are frictionally-interlocked and not coherently-bonded to one another by a coating of said hot-melt adhesion promoter composition.
